(19) United States
(12) Patent Application Publication
(10) Pub. No.: US 2015/0198996 A1
(43) Pub. Date: Jul. 16, 2015

(54) DYNAMICALLY ADJUSTABLE POWER USAGE

(71) Applicants: Jonathan Foster KLIEGMAN, Kitchener (CA); Seyed Behdad Esfahbod MirHosseinZadeh SARABI, Toronto (CA); Kevin Glen Roy GREER, Mississauga (CA); Ryan James HARRISON, Kitchener (CA); Wojciech BARANOWSKI, Gdynia (PL); Fady SAMUEL, Kitchener (CA); Kevin Anthony ELLIS, Kitchener (CA)

(72) Inventors: Jonathan Foster KLIEGMAN, Kitchener (CA); Seyed Behdad Esfahbod MirHosseinZadeh SARABI, Toronto (CA); Kevin Glen Roy GREER, Mississauga (CA); Ryan James HARRISON, Kitchener (CA); Wojciech BARANOWSKI, Gdynia (PL); Fady SAMUEL, Kitchener (CA); Kevin Anthony ELLIS, Kitchener (CA)

(73) Assignee: GOOGLE INC., Mountain View, CA (US)

(21) Appl. No.: 13/421,775

(22) Filed: Mar. 15, 2012

(51) Int. Cl. G06F 1/32

(52) U.S. Cl. CPC G06F 1/3212; G06F 1/3287

(57) ABSTRACT

Techniques for managing power consumption are described herein. In some embodiments, the subject technology provides a method for managing power consumption in a battery powered device, the method comprising steps for determining a user engagement with a battery powered device, wherein the battery powered device comprises one or more hardware components, calculating a power time duration for which the battery powered device is to be maintained in a powered state based on the user engagement with the battery powered device and automatically adjusting power consumption characteristics of the one or more hardware components based on the power time duration. Systems and computer-readable media are also provided.

### BACKGROUND

Some conventional power management methods use predefined hardware configurations (e.g., power “profiles”) for use in managing power consumption. These profiles are sometimes accompanied by an indication of an estimated performance/power efficiency tradeoff. For example, a user may be presented with multiple power configuration options or “levels” e.g., high-performance/low-efficiency or low-performance/high-efficiency, etc. In some instances, conventional power profiles also provide the user with an estimated battery life duration based on the configuration characteristics of the associated profile.

### SUMMARY

The disclosed subject matter relates to a computer-implemented method for managing power consumption, comprising, determining a user engagement with a battery powered device, wherein the battery powered device comprises one or more hardware components, calculating a power time duration for which the battery powered device is to be maintained in a powered state based on the user engagement with the battery powered device and automatically adjusting power consumption characteristics of the one or more hardware components based on the power time duration.

The disclosed subject matter also relates to a system for managing power consumption, the system comprising one or more processors and a computer-readable medium comprising instructions stored therein, which when executed by the processors, cause the processors to perform operations comprising, determining a user engagement with a battery powered device, wherein the battery powered device comprises one or more hardware components and calculating a power time duration for which the battery powered device is to be maintained in a powered state. In certain aspects, the processor is further configured to perform operations for automatically adjusting power consumption characteristics of the one or more hardware components based on the power time duration and the user engagement with the battery powered device.

The disclosed subject matter also relates to a computer-readable medium comprising instructions stored therein, which when executed by a processor, cause the processor to perform operations comprising determining a user engagement with a battery powered device, wherein the battery powered device comprises one or more hardware components, calculating a power time duration for which the battery powered device is to be maintained in a powered state and automatically adjusting performance characteristics of the one or more hardware components based on the power time duration and the user engagement with the battery powered device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the disclosed aspects. In the drawings:

FIG. 1 illustrates a flow diagram of an example method for managing power consumption, according to certain aspects of the subject disclosure.

FIG. 2 illustrates a flow diagram of an example method for notifying a user if a power time duration does not exceed a time required for completion of one or more tasks, according to certain aspects of the subject disclosure.

FIG. 3 illustrates a flow diagram of an example method for providing an indication to a user of one or more power adjustment options, according to certain aspects of the subject disclosure.

FIG. 4 illustrates an example of an electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Although some conventional power management methods use various predefined hardware configurations for managing power consumption, traditional methods do not provide the ability to determine a power time duration for which the battery powered device is to be maintained in a powered state and to automatically adjust power consumption based on the determined power time duration.

The subject technology provides a method for automatically and dynamically adjusting hardware characteristics in order to provide power needed to achieve a target power time duration e.g., the time duration for which a device will need to remain in a powered ‘on’ state. In order to adjust the overall power consumption of the battery powered device, power consumption characteristics of one or more hardware components of the battery powered device can be adjusted. Because, ongoing changes in device use can affect battery life, in some aspects the subject technology provides for the dynamic re-adjustment of power consumption characteristics (e.g., by changing performance or power state characteristics of specific hardware components), based on changes in how the user is engaged with the battery powered device. In some implementations, where the battery life cannot meet user expectations, the user may be presented with a list of power adjustment options.

Depending on the implementation, the power time duration can be determined in several ways. In some implementations, the power time duration may be based on an input provided by the user, for example, a user may specify a power time duration for which he/she wishes to use the battery powered device. By way of example, a user boarding an airplane may know that use of a wireless device will be required for the entire flight duration. Thus, the power time duration may be, at least in part, based on an input provided directly by the user input e.g., corresponding to a three hour duration.

The power time duration can also be automatically determined based on a time required for the user to complete a particular task. If the user is playing media content having a discrete run time (e.g., a movie or music) then the remaining playtime may be used to determine the power time duration. For example, if the user begins watching a DVD with a runtime of two hours, then the power time duration may be determined to be at least two hours.

In other implementations, the power time duration may be calculated from a variety of information items pertaining to user history and/or user behavior. For example, if a user typically uses his wireless device to check email for two hours, starting at a particular time each night, then the power time duration at that particular time may be determined to be two hours.

Power consumption adjustments to the battery powered device can be made in a variety of ways. In some aspects, power consumption adjustments will be automatically made based on the activities or tasks being performed by the user. For example, power consumption and/or performance characteristics of one or more hardware components of the battery powered device can be adjusted to minimize the power consumption (or performance) of hardware components that are not being used or will minimally impact the user's experience. By way of example, if a user is watching a DVD, but not utilizing an Internet connection, full power to a DVD drive and display device may be maintained, while power to a wireless Internet card may be completely stopped.

In certain aspects, power consumption adjustments will be made dynamically based on changing user behaviors e.g., changes in tasks and/or activities that are being performed by the user. By way of the above example, if the user watching the DVD opened a browser and began surfing the Internet, a reduction may occur in the power delivered to the display, while optimal power levels would be delivered to the DVD drive and wireless Internet card (e.g., display performance may be somewhat reduced in order to support other functions required by the user).

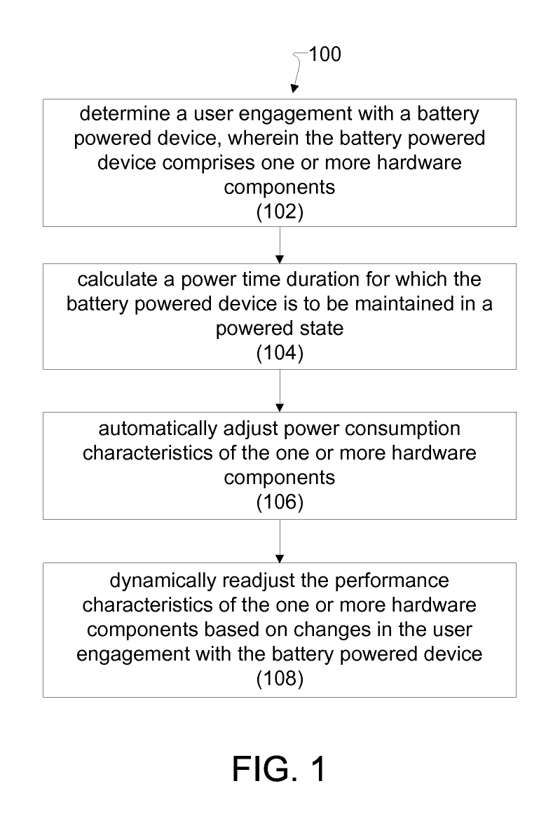

FIG. 1 illustrates a flow diagram of an example method 100 for managing power consumption, according to certain aspects of the subject disclosure. The method 100 begins with step 102 in which a user engagement with a battery powered device is determined. As used herein “battery powered device” can comprise any electrical or electronic device that draws power from a storage source e.g., a battery. Battery powered devices may include, but are not limited to, wireless phones (e.g., “smart” phones or PDAs, etc.), mobile computing devices (e.g., tablet-based computing devices, laptops, e-readers, etc.) and/or portable electronic devices such as portable music players (e.g., MP3 players, etc.). In certain aspects, the battery powered device may comprise one or more hardware components. For example, a mobile computing device such as a laptop, may comprise multiple hardware components such as one or more processors (e.g., one or more CPUs and/or GPUs) and/or multiple communication devices e.g., wired and/or wireless network communication devices.

In certain implementations, a determination of the user's engagement with the battery powered device will include a determination of what hardware components are required to enable an activity or task being performed by the user. For example, if the user is streaming a video from the Internet, the battery powered device may need to supply power to one or more network communication devices (to receive the video stream) and to a display device (to display the video).

In step 104, a power time duration is calculated for which the battery powered device is to be maintained in a powered state. As used herein, “power time duration” refers to a time duration for which the battery powered device can be maintained in a powered ‘on’ state, while maximizing hardware performance. The power time duration can be based on a number of considerations, including but not limited to, an amount of power available from the battery, user use and performance tradeoffs. In some implementations, the power time duration will exceed the time duration necessary to allow the user to complete one or more activities/tasks in which he/she is engaged. The power time duration can be determined using any information related to the user, the battery powered device and/or related to the user's engagement with the battery powered device. In some aspects, the power time duration may also be determined based on an input specified by the user e.g., a minimum time duration specified by the user indicating how long the user would like to keep the device powered ‘on.’

In certain aspects, the power time duration may be calculated using information related to the user. Although any information related to the user could be used for calculating the power time duration, in some examples, information related to a user's activity/usage history (e.g., hardware, software, web app and/or webpage usage history, etc.), can be used. In certain implementations, the power time duration may be calculated using usage history information that has been aggregated across many users. Usage history information calculated across multiple users may be useful, for example, in calculating a power time duration for a computing session in which the user is engaged in use of a new application/web app or activity in which no history information is available for that particular user.

By way of example, if a user habitually spends thirty minutes checking and reading email, at which point the user then turns ‘off’ the battery powered device, the user's habits may be reflected in activity/usage history information. Thus, based on the activity/usage information for the user, the system may determine that the power time duration must exceed a time duration of at least thirty minutes.

In another example, a user may power on a battery-powered device at 8 PM everyday and read web pages for approximately one hour, before then shutting down the device. Based on user history information, a power time duration of at least one hour may be calculated to ensure that the user has enough time to read web pages beginning at 8 PM.

The calculation of the power time duration may also be based on information related to the user's engagement with the battery powered device, as determined above with respect to step 102. For example, the user's engagement with the battery powered device may indicate that the device will be used for a minimally determinable time period. By way of example, if the user begins to play multimedia content (e.g., video or audio having a predetermined run-time), then the power time duration may be based on the run-time of the content.

In step 106, power consumption characteristics of one or more of the hardware components are adjusted. As discussed above, the hardware components may comprise any electrical or electronic devices that are integral with, or connected to, the battery powered device. In certain aspects, power consumption characteristics of a particular hardware component may be adjusted by either starting or stopping delivery of power to the hardware component. For example, if it is determined that a user is not using a particular network communication device, power consumption may be adjusted by stopping delivery of power to the network communication device. In some aspects, the adjustment of power consumption characteristics for a hardware device may include the adjustment of an amount of power delivered to the device. For example, power adjustments to a display device may involve increasing/decreasing a brightness level of the display. Similarly, power adjustments to a processor may involve increasing or decreasing the clock speed of the processor.

In step 108, performance characteristics of one or more hardware components may be readjusted based on changes in the user engagement with the battery powered device. By way of example, a user may be using an optical drive of the battery powered device to watch a movie stored on an optical disk. As such, full power may be delivered to the optical drive, as well as a display device for displaying the movie. If the user stops watching the movie and instead begins browsing the internet, delivery of power to the optical drive may be stopped altogether, whereas delivery of power delivered to the display may be slightly decreased.

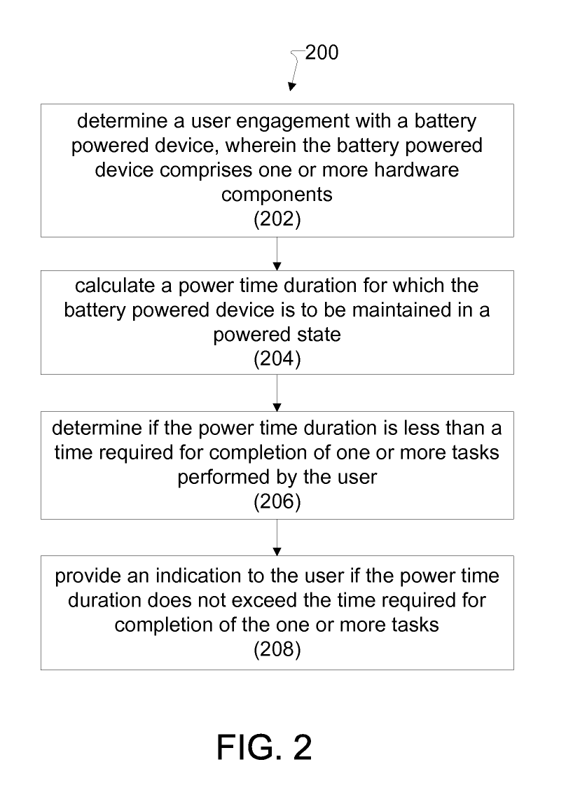

FIG. 2 illustrates a flow diagram of an example method 200 for notifying a user if a power time duration does not exceed a time required for completion of one or more tasks, according to certain aspects of the subject disclosure. The method 200 begins with step 202 in which a user engagement with a battery powered device is determined. As described above with respect to step 102, a determination of the user's engagement with the battery powered device can include a determination as to what hardware components are required to enable or facilitate an activity or task performed by (or to be performed by) the user. By way of example, if the user is engaged in playing a game, the battery powered device may need to supply optimal power to one or more processors (e.g., one or more CPUs or GPUs), for use in processing and rendering information related to the user's game play.

In step 204, a power time duration is determined for which the battery powered device is to be maintained in a powered state. As discussed above with respect to step 104 of the method 100, the power time duration may be determined using any type available information, including but not limited to, information about one or more users, information about the battery powered device and/or information related to the user's engagement with the battery powered device, etc.

In step 206, it is determined whether the power time duration is less than a time required for completion of one or more tasks being performed (or to be performed) by the user. In certain aspects, this determination will comprise a determination as to whether or not power consumption adjustments can be made that will enable the user to complete one or more activities/tasks in which the user is engaged. For example, a user may begin playing a video from an optical disk (e.g., a movie stored on a Blu-ray disc) having a duration of 2.5 hours. Thus, completion of the user's current activities (e.g., watching the movie) could require a minimum of 2.5 hours of operation from the battery powered device. Based on current battery levels, as well as other factors (e.g., other activities/tasks being performed by the user) a determination will be made as to whether the battery powered device can be maintained in an ‘on’ state for the required time duration.

In step 208, an indication is provided to the user if the power time duration does not exceed the time required for completion of the one or more tasks being performed by the user. By way of the above example, if the power time duration does not meet or exceed 2.5 hours, an indication may be provided to the user. In some aspects, the notification may comprise a warning that the user's current activities/tasks may not be supported using the remaining battery life. In certain implementations, the indication may include a list of user selectable power management options, for example, that can help the user in allocating power resources.

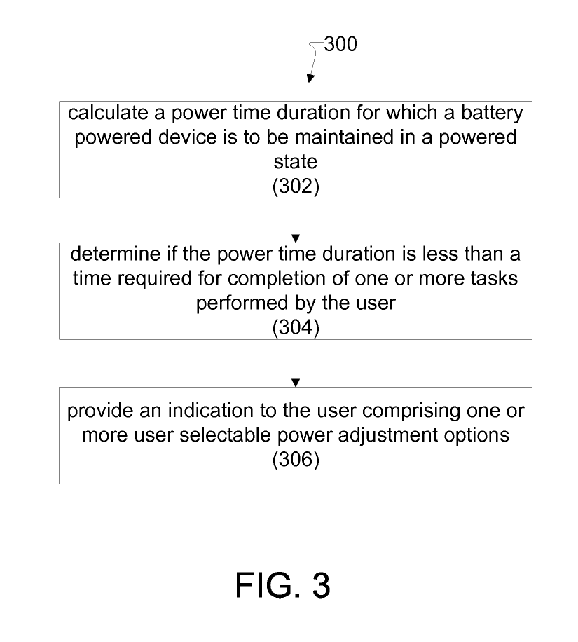

FIG. 3 illustrates a flow diagram of an example method 300 for providing an indication to a user of one or more power adjustment options, according to certain aspects of the subject disclosure. The method 300 begins with step 302 in which a power time duration is calculated for which a battery powered device is to be maintained in a powered state. As discussed above, the power time duration may be determined using any type available information, including but not limited to, information about one or more users, information about the battery powered device and/or information related to the user's engagement with the battery powered device, etc. In some examples, the calculation of the power time duration may be based on historic use data related to one or more users performing one or more tasks.

In step 304, a determination is made as to whether or not the power time duration is less than a time required for completion of one or more tasks that are being performed by the user. By way of example, if the power time duration is determined to be 45 minutes, and then the user begins watching a movie with a run time of 2 hours, it may be determined that the power time duration is not sufficient to keep the device powered ‘on’ for the duration of the user task.

In step 306, an indication is provided to the user comprising one or more user selectable power adjustment options. As discussed above, in certain implementations, the indication may include a list of user selectable power management options, for example, that can help the user in allocating power resources. Through selection of a power management option, power consumption of the battery-powered device may be manually controlled by the user. The power state and/or performance characteristics of any hardware component of the battery powered device may be altered to control the rate of power consumption. By way of example, power management options may allow the user to choose power consumption or performance characteristics pertaining to screen brightness, a number of CPU cores that are enabled/disabled, a CPU clock-rate, enable/disable GPS, etc. Power management options can further effect the enabling/disabling of a 3G/WAN modem or a Wifi/LAN modem, alter a time delay related to a hard-disk/optical-disk head parking timeout, alter screen-saver timeout settings, etc. In some implementations, power management settings may alter software characteristics such as operating system or application behavior. For example, power management options may be used to kill/suspend active applications or webpages, configure or reconfigure time intervals for things like checking for new emails and/or changing graphic interface look & feel options, i.e., alpha-blending, animations, gradients, etc.

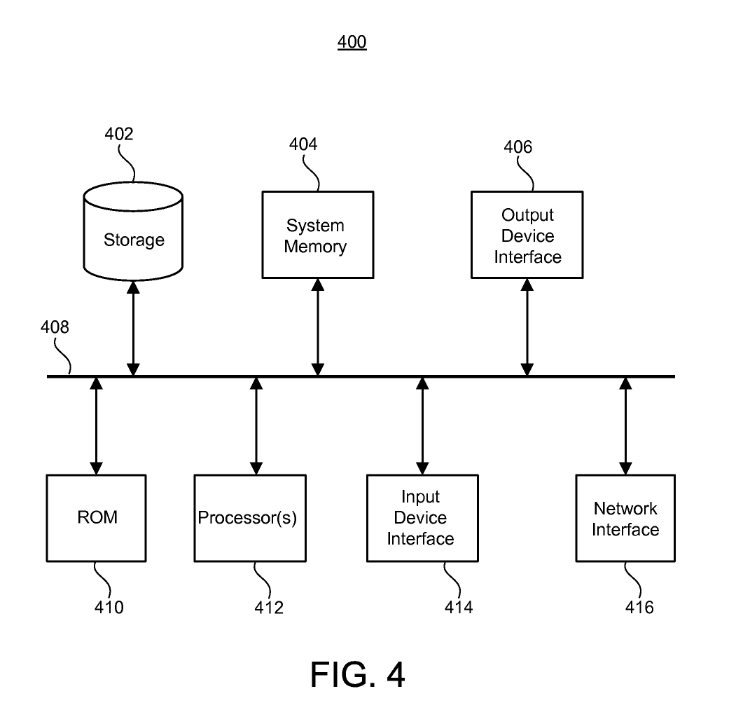

FIG. 4 illustrates an example of an electronic system 400 with which some aspects of the subject technology can be implemented. In some examples, the electronic system 400 can be a single computing device such as a server (e.g., the first server 404 and/or the second server 406, discussed above). Furthermore, in some implementations, the electronic system 400 can be operated alone or together with one or more other electronic systems e.g., as part of a cluster or a network of computers.

As illustrated, the processor-based system 400 comprises storage 402, a system memory 404, an output device interface 406, system bus 408, ROM 410, one or more processor(s) 412, input device interface 414 and a network interface 416. In some aspects, the system bus 408 collectively represents all system, peripheral, and chipset buses that communicatively connect the numerous internal devices of the processor-based system 400. For instance, system bus 408 communicatively connects the processor(s) 412 with the ROM 410, the system memory 404, the output device interface 406 and the permanent storage device 402.

In some implementations, the various memory units, the processor(s) 412 retrieve instructions to execute (and data to process) in order to execute the steps of the subject technology. The processor(s) 412 can be a single processor or a multi-core processor in different implementations. Additionally, the processor(s) can comprise one or more graphics processing units (GPUs) and/or one or more decoders, depending on implementation.

The ROM 410 stores static data and instructions that are needed by the processor(s) 412 and other modules of the processor-based system 400. Similarly, the processor(s) 412 can comprise one or more memory locations such as a CPU cache or processor in memory (PIM), etc. The storage device 402, is a read-and-write memory device. In some aspects, this device can be a non-volatile memory unit that stores instructions and data even when the processor-based system 400 is without power. Some implementations of the subject disclosure can use a mass-storage device (such as solid state, magnetic or optical storage devices) e.g., a permanent storage device 402.

Other implementations can use one or more a removable storage devices (e.g., magnetic or solid state drives) such as permanent storage device 402. Although the system memory can be either volatile or non-volatile, in some examples the system memory 404 is a volatile read-and-write memory, such as a random access memory. System memory 404 can store some of the instructions and data that the processor needs at runtime.

In some implementations, the processes of the subject disclosure are stored in system memory 404, permanent storage device 402, ROM 410 and/or one or more memory locations embedded with the processor(s) 412. From these various memory units, processor(s) 412 retrieve instructions to execute and data to process in order to execute the processes of some implementations of the instant disclosure.

The bus 408 also connects to the input device interface 414 and output device interface 406. The input device interface 414 enables a user to communicate information and select commands to the processor-based system 400. Input devices used with the input device interface 414 may include for example, alphanumeric keyboards and pointing devices (also called “cursor control devices”) and/or wireless devices such as wireless keyboards, wireless pointing devices, etc.

Finally, as shown in FIG. 4, bus 408 also communicatively couples the processor-based system 400 to a network (not shown) through a network interface 416. It should be understood that the network interface 416 can be either wired, optical or wireless and may comprise one or more antennas and transceivers. In this manner, the processor-based system 400 can be a part of a network of computers, such as a local area network (“LAN”), a wide area network (“WAN”), or a network of networks, such as the Internet. In some examples, the processor based system 400 may be a part of a telephone network, such as a wireless telephone network, a wired telephone network (e.g., a public switched telephone network) or a private telephone network (e.g., a PBX).

In practice the methods of the subject technology can be carried out by the processor-based system 400. In some aspects, instructions for performing one or more of the method steps of the present disclosure will be stored on one or more memory devices such as the storage 402 and/or the system memory 404.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for managing power consumption, comprising:
automatically determining, by one or more processors, a user engagement with a battery powered device, wherein the battery powered device comprises one or more hardware components;
determining which of the one or more hardware components are required to enable an activity of the battery powered device;
calculating, by one or more processors, a power time duration for which the battery powered device is to be maintained in a powered state based on the user engagement with the battery powered device and user history information that has been aggregated across multiple users; and
automatically adjusting, by one or more processors, power consumption characteristics of the one or more hardware components based on the power time duration.

2. The method of claim 1, wherein the power time duration is calculated based on a user specified time duration.

3. (canceled)

4. The method of claim 1, wherein the power time duration is calculated based on a prediction of one or more tasks that may be performed by the user.

5. The method of claim 1, further comprising:
determining if the power time duration is less than a time required for completion of one or more tasks performed by the user; and
providing an indication to the user if the power time duration does not exceed the time required for completion of the one or more tasks.

6. The method of claim 1, further comprising:
determining if the power time duration is less than a time required for completion of one or more tasks being performed by the user; and
providing an indication to the user comprising one or more user selectable power adjustment options.

7. The method of claim 1, further comprising:
dynamically readjusting the performance characteristics of the one or more hardware components based on changes in the user engagement with the battery powered device.

8. A system for managing power consumption, the system comprising:
one or more processors; and
a computer-readable medium comprising instructions stored therein, which when executed by the processors, cause the processors to perform operations comprising:
automatically determining a user engagement with a battery powered device, wherein the battery powered device comprises one or more hardware components;
determining which of the one or more hardware components are required to enable an activity of the battery powered device;
calculating a power time duration for which the battery powered device is to be maintained in a powered state based on user history information that has been aggregated across multiple users; and
automatically adjusting power consumption characteristics of the one or more hardware components based on the power time duration and the user engagement with the battery powered device.

9. The system of claim 8, wherein the power time duration is calculated based on a user specified time duration.

10. The system of claim 8, wherein the power time duration is calculated based on the user engagement with the battery powered device.

11. (canceled)

12. The system of claim 8, wherein the power time duration is calculated based on a prediction of one or more tasks that will be performed by the user on the battery powered device.

13. The system of claim 8, wherein the processor is configured to perform operations further comprising:
determining when the power time duration is less than a time required for completion of one or more tasks performed by the user; and
providing an indication to the user that the power time duration does not exceed the time required for completion of the one or more tasks.

14. The system of claim 8, wherein the processor is configured to perform operations further comprising:
determining when the power time duration is less than a time required for completion of one or more tasks being performed by the user; and
providing an indication to the user comprising one or more user selectable power adjustment options.

15. The system of claim 8, wherein the processor is configured to perform operations further comprising:
dynamically readjusting the performance characteristics of the one or more hardware components based on changes in the user engagement with the battery powered device.

16. A non-transitory computer-readable medium comprising instructions stored thereon, which when executed by a processor, cause the processor to perform operations comprising:
automatically determining a user engagement with a battery powered device, wherein the battery powered device comprises one or more hardware components;
determining which of the one or more hardware components are required to enable an activity of the battery powered device;
calculating a power time duration for which the battery powered device is to be maintained in a powered state based on user history information that has been aggregated across multiple other users when no history information is available for the user determined to be engaged with the battery powered device; and
automatically adjusting performance characteristics of the one or more hardware components based on the power time duration and the user engagement with the battery powered device.

17. The non-transitory computer-readable medium of claim 16, further comprising:
determining when the power time duration is less than a time required for completion of one or more tasks performed by the user; and
providing an indication to the user that the power time duration does not exceed the time required for completion of the one or more tasks.

18. The non-transitory computer-readable medium of claim 16, further comprising:
determining when the power time duration is less than a time required for completion of one or more tasks being performed by the user; and
providing an indication to the user comprising one or more user selectable power adjustment options.

19. The non-transitory computer-readable medium of claim 16, further comprising:
dynamically readjusting the performance characteristics of the one or more hardware components based on changes in the user engagement with the battery powered device.

20. The non-transitory computer-readable medium of claim 16, wherein the power time duration is calculated based on a user specified time duration.
